(19) United States
(12) Patent Application Publication
(10) Pub. No.: US 2005/0112248 A1
(43) Pub. Date: May 26, 2005

(54) Electron beam carcass irradiation system

(76) Inventor: Richard A. Galloway, East Islip, NY (US)

Correspondence Address: W. Robinson H. Clark;DORSEY & WHITNEY LLP, Intellectual Property Department, 1001 Pennsylvania Avenue, NW, Suite 400 South, Washington, DC, 20004-2533, US

(21) Appl. No.: 10/995,102

(22) Filed: Nov. 24, 2004

Related U.S. Application Data
(60) Provisional application No. 60/525,411, filed on Nov. 26, 2003.

(51) Int. Cl. C12H 1/06

(52) U.S. Cl. 426/237; 426/532

(57) ABSTRACT

The invention is a method and system for irradiating carcasses with low energy electrons (between 500 keV and 4.0 MeV) and carcasses generated by the same. Pathogens on a carcass dwell in the outermost tissue layers. The invention accelerates electrons to an energy sufficient to penetrate the outermost tissue layers, which mostly comprise skin and/or fat tissue, but insufficient to penetrate the deeper layers that contain the majority of muscle tissue. The irradiation kills the pathogens. The irradiated tissue can then be removed to expose non-irradiated, pathogen free, muscle tissue which can then be cut and processed. Alternatively, the carcass can be cut into portions that contain minimal irradiated tissue. In this manner, minimal electron beam energy produces maximal pathogen reduction. In addition, it may not be necessary to label meat derived from this method and system as “irradiated”—because only outer layers that are removed or represent a small portion the product are irradiated.

### 1.0 CROSS-REFERENCE TO RELATED APPLICATIONS

This patent application claims benefit to U.S. provisional patent application No. 60/525,411 filed Nov. 26, 2003.

### 2.0 BACKGROUND OF THE INVENTION

2.1 Field

The invention is directed to a method and system for reducing the level of pathogens in carcasses and to carcasses obtained using the same. More particularly, the invention is directed to a method and system for using low energy electron beams to penetrate the outermost layers of carcasses to reduce the level of pathogens therein and to carcasses obtained using the same.

2.2 Description of Related Art

Meat is easily contaminated by one or more of a wide array of pathogens including, but not limited to, E. Coli O-157, Salmonella, Campylobacter and Listeria. The internal organs of livestock—especially the intestinal canals—are rich in pathogens. Accordingly, these organs are typically removed (“eviscerated”) during butchering. However, the intestinal contents can leak and adhere to the surface of the carcass. In addition, pathogens born in the air or spread through handling can form on the surface of meat under even the most sanitary conditions. Therefore, the presence and proliferation of pathogens, through natural causes and cross-contamination, is a serious problem in the food industry. In order to reduce the potential for food borne illnesses, the level of pathogens must be reduced.

It is known in the art to reduce the level of pathogens by treating animal carcasses or meat derived therefrom with steam. See International Publication No. WO 96/13983 and Comparison of Steamed Pasteurizaation and Other Methods of Reduction of Pathogens on Surfaces of Freshly Slaughtered Beef, Phebous et al., Journal of Food Production, vol. 60, no. 5, pp. 476-484 (1997). It is also known to dip cuts of meat in hot water. See U.S. Pat. No. 6,569,482 Reduction in Microbial Load on Buffalo Meat By Hot Water Dip Treatment, Sachindra et al., Meat Science, vol. 48, no. ½, pp. 149-157 (1998). It is also known to treat meat with chlorinated bactericides, such as hypochlorous acid and sodium hypochlorite, as well as organic acids such as lactic acid and peracetic acid. U.S. patent application Ser. No. 2003/0100254 A1 also describes a method for sterilizing mammal carcasses using aqueous hinokitiol.

However, all of these techniques have drawbacks. Moisture, whether in the form of hot water or steam, causes red meat to lose its flavor. Chlorinated bactericides are unstable and produce gaseous chloride which is harmful to humans. Lactic acid changes the color of meat and, thereby, makes it less marketable. More importantly, none of these techniques are suitably effective as evidenced, among other things, by periodic outbreaks of food poisoning due to contaminated meat.

Irradiation is a safe and effective means to kill bacteria and parasites in food products. Irradiation uses gamma rays, x-rays or high voltage electrons to kill potential bacteria and parasites and increase shelf life. Irradiation is sometimes referred to as “ionizing radiation” because it produces energy waves strong enough to dislodge electrons from atoms and molecules, thereby converting them to charged particles called ions. Ionizing radiation reduces the level of disease causing organisms in food by disrupting their molecular structure and thereby killing them. Since 1963, the U.S. Food and Drug Administration (FDA) and the U.S. Department of Agriculture (USDA), through its Food Safety and Inspection Service (FSIS), have permitted the use of irradiation on more and more commercially sold food products. Irradiation was approved for use on wheat and flour in 1963, on vegetables and spices in 1986, on poultry in 1992 and on meat products in 1997.

However, the FDA and FSIS require food products that have undergone irradiation to be labeled as “irradiated,” “treated with radiation” or “treated by irradiation” and include a radura (the international symbol for irradiation). These labels cause some consumers to mistakenly believe irradiated products are radioactive. In addition, some consumer groups argue that pasteurization of any type breaks down necessary proteins and, thereby, makes the product less healthy.

Accordingly, it would be desirable to develop a method and system that permits the benefits of irradiation without invoking labeling requirements. In addition, it would be desirable to develop a method and system that maximizes the sterilizing benefits of irradiation in meat at a given energy.

### 3.0 BRIEF DESCRIPTION OF THE SEVERAL VIEWS OF THE DRAWINGS

The skilled artisan will understand that the drawings, described below, are for illustration purposes only. The drawings are not intended to limit the scope of the present teachings in any way.

FIG. 1 is a graph demonstrating how electron beam energy is deposited on a carcass.

FIG. 2 is a graph showing the dose deposition curve for 2.0 MeV electrons in fat.

FIG. 3 is a graph showing the dose deposition curves for 1.0 MeV, 2.0 MeV, 3.0 MeV and 4.0 MeV electrons in fat tissue.

FIG. 4 is a graph showing the dose deposition curves for 1.0 MeV, 2.0 MeV, 3.0 MeV and 4.0 MeV electrons in muscle tissue.

FIG. 5 is a graph showing the dose deposition curves for 1.0 MeV, 2.0 MeV, 3.0 MeV and 4.0 MeV electrons in bone tissue.

FIG. 6 is a graph showing the dose deposition curves for 1.0 MeV, 2.0 MeV, 3.0 MeV, and 5.0 MeV electrons in over lying layers of fat, muscle and bone tissue that mimic conditions that can be expected in a real carcass.

FIG. 7 illustrates an electron accelerator and scanner that can be used in the invention.

FIGS. 8(A), 8(B) and 8(C) provide front, angled and elevated views, respectively, of a two electron accelerator configuration with scanners, support frame and carcass conveyor that can be utilized in the invention.

FIGS. 9(A), 9(B), 9(C) and 9(D) provide front, angled, overhead and side views, respectively, of another configuration where a single power supply powers two accelerator heads.

FIGS. 10(A), 10(B) and 10(C) provide side, angled and opposing angled views, respectively, of a single electron accelerator configuration with scanner, support frame and carcass conveyor that can be utilized in the invention.

### 4.0 SUMMARY OF THE INVENTION

The invention is directed to a method and system for treating carcasses with low energy electrons and to carcasses obtained using the same. Virtually all pathogens dwell in the outermost layers of a carcass, which are mostly skin and/or fat. The invention accelerates electrons to an energy sufficient to penetrate the outermost layers but insufficient to penetrate a majority of the deeper lying muscle tissue. The irradiation kills the pathogens.

The invention is more efficient than previous irradiation processes that fully penetrate small portions of cut or ground meat with ionizing irradiation. In addition, because a majority of the deeper muscle tissue on the carcass is not subjected to ionizing energy, the meat derived solely therefrom as not “irradiated” and need not labeled as such. Furthermore, depending on pending FDA and FSIS decisions, meat cut from the portions of the carcass that include irradiated tissue may still be exempt from labeling requirements if cut to contain a minority of irradiated tissue. This increases the marketability of the meat.

Accordingly, in one embodiment, the invention comprises a method for reducing the level of pathogens on carcasses. The first step in the method is the generation and acceleration of electrons to an energy between 500 keV and 4.0 MeV. Next, the carcasses are moved past one or more scanners using one or more conveyors. The scanners direct accelerated electrons onto and into each carcass. The electrons penetrate each carcass to a substantially uniform depth that is less than the total depth of tissue on the carcass. Usually, the irradiated tissue is primarily skin and/or fat tissue. A majority of the deeper muscle and bone tissue on the carcass is not irradiated. Irradiated tissue is then removed from each carcass and the exposed, non-irradiated meat, is processed. Alternatively, some or all of the irradiated tissue can remain on the carcass and the carcass can be cut into meat portions that contain less than 50% irradiated tissue.

In another embodiment, the invention comprises a system for reducing the level of pathogens on carcasses. The system comprises one or more carcass conveyors, one or more accelerators that accelerate electrons to an energy between 500 keV and 4.0 MeV and one or more scanners that direct accelerated electrons onto and into carcasses conveyed past the scanners. Each scanner is sufficiently large to irradiate the entire side of a carcass. In addition, the system comprises a first computer that controls surface dose by controlling electron current, conveyor speed and the number of passes a carcass makes through the system. Finally, the system includes a second computer, that can be the first computer, that controls the energy of the electrons to insure tissue on each carcass is irradiated to a depth less than the total depth of tissue on the carcass.

Adjustment of the electron beam energy effectively controls the depth of treatment. Regulation of the electron beam current, product treatment time, beam scanning and other parameters allow for a controlled dose to be delivered to the carcass that is sufficient to kill the pathogens therein. The dose is adjustable through these parameters and may be set according to whatever level is necessary to reduce the level of live pathogens within limits set in guidelines for processing various meats.

In yet another embodiment, the invention is a carcass generated by the process or system described above. The carcass comprises skin and/or fat tissue, muscle tissue and bone tissue. The outer layers of the carcass (e.g., the outer 5 to 20 mm), usually comprised primarily of skin and/or fat tissue, have been irradiated with ionizing electrons to a substantially uniform depth. The remainder of the carcass is not irradiated. The carcass is substantially free of pathogens.

These and other features of the invention are set forth herein.

### 5.0 DETAILED DESCRIPTION OF THE INVENTION

5.1 Definitions

Unless defined otherwise, all technical and scientific terms used herein have the meaning commonly understood by those of ordinary skill in the art. The following words and phrases have the following meanings:

The word “pathogen” means any living micro or macro agent that can cause disease in humans including bacteria, fungi and viruses.

The word “carcass” refers to a large portion of an animal (e.g., a cow, pig or chicken) that has been slaughtered. Generally, a carcass represents the entire body of the animal after it is slaughtered, bleed and eviscerated. The carcass may be skinned or the skin may remain partially or fully intact. A carcass can be cut into from two to six body portions along the spine and major joint lines. Such body portions are large enough to still be embraced by the word “carcass” as used herein.

5.2 Electron Beam Irradiation Generally

Accelerators are machines that use electrical energy to generate free electrons, accelerate them to high speeds (thereby endowing them with high kinetic energies) and direct them at materials typically carried on a conveyor or another type of flow-through system. The energetic electrons penetrate the material, excite and ionize the atoms and molecules and destroy the DNA of the pathogens.

Accelerators are similar to TV sets or medical X-ray machines in the way they generate electrons. All produce a cloud of free electrons by heating a negative cathode inside a vacuum chamber. Once generated, the negatively-charged electrons are repelled by the negative electrical potential on the cathode and are attracted by the grounded anode plate.

In a direct accelerator, like the RDI DYNAMITRON®, the negative voltage applied to the cathode determines the total kinetic energy of the electrons. In an microwave linear (linac) accelerator, or a radio frequency (RF) accelerator such as an IBA Rhodotron®, the electrons are accelerated to a relatively low energy (typically 25 to 50 keV) and then injected into an electron accelerating structure and accelerated to higher kinetic energies with alternating electric fields. The accelerated electrons escape through a thin metallic window (e.g., a 0.04 mm thick titanium window) mounted in the grounded anode plate and proceed through the air towards the material to be treated. A typical air gap between the window and material to be treated is 6 inches (152.4 mm).

5.3 Low Electron Beam Energies

The dose a product receives is controlled by how many electrons are delivered to the product and is independent of electron beam energy. However, the penetration of the dose internal to the product is determined by electron beam energy. Electrons have a predictable penetration depth, or range, in a given material. The range is affected by two parameters: electron energy and product density. Penetration is proportional to the beam energy and inversely proportional to the product density.

Beam energy is typically referred to in MeV (Mega Volts or millions of electron volts). All things being equal, a 10 MeV electron beam will penetrate approximately 10 times deeper than a 1 MeV beam.

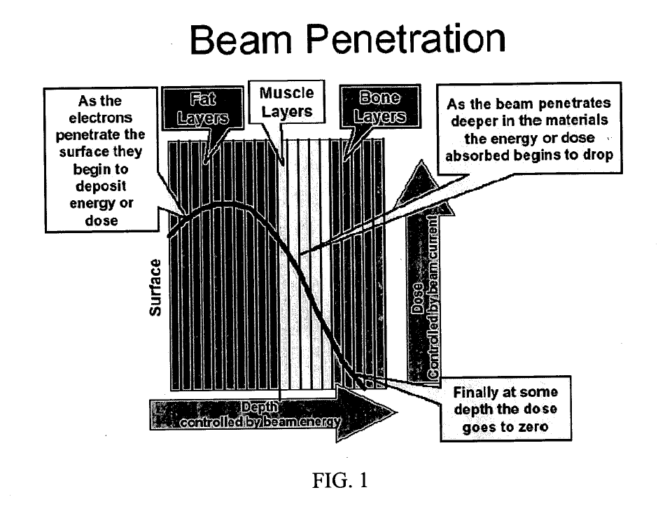

FIG. 1 demonstrates how electron beam energy is deposited on a carcass. A carcass generally contains skin and/or fat tissue overlying muscle tissue overlying bone tissue. The exact depth of each tissue type depends on the species and health of the animal. A cattle carcass from a healthy animal, for example, typically contains between 10 and 25 mm of outer fat tissue. The transition between fat and muscle tissue can be gradual as the tissue types can, and do, intermix within certain regions.

FIG. 1 shows that electrons entering the surface of a carcass deliver a dose that initially increases as the electrons penetrate the carcass. At a point below the surface of the carcass, the dose reaches a maximum, which is generally 50 to 60% greater than the surface dose. After the maximum, the dose drops as energy from the electron beam is absorbed. At some point in depth, depending on the energy of the electron beam employed, the dose absorbed drops to zero. The material beyond this point in depth receives no dose and is not irradiated material.

To determine the appropriate energies for use in the invention, the following data was collected:

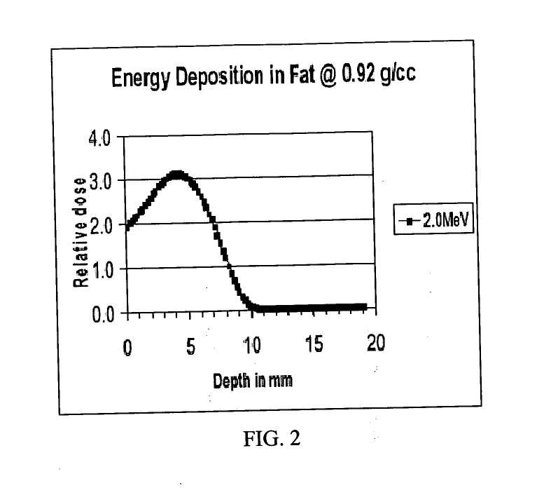

FIG. 2 provides the dose deposition curve for a 2.0 MeV electron beam in fat tissue. The outermost layers of a carcass are often primarily skin and/or fat tissue. Fat tissue has a density of about 0.92 g/cc. The dose increases to a maximum at a point approximately 4.2 mm within the fat tissue then drops to zero at a point approximately 10 mm within the fat tissue. The depth of the deposited dose is a function of the beam energy and the mass and stopping power of the particular material.

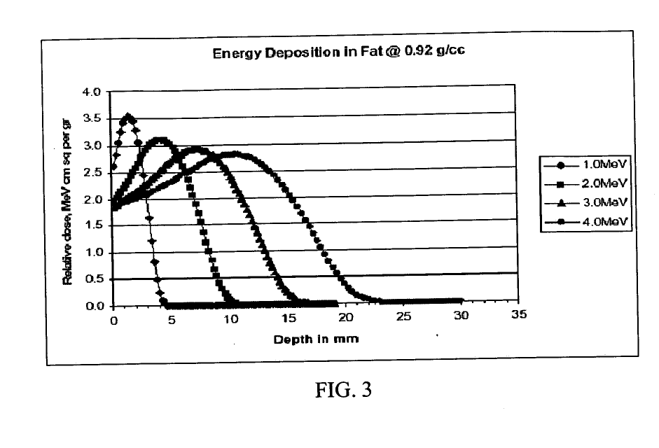

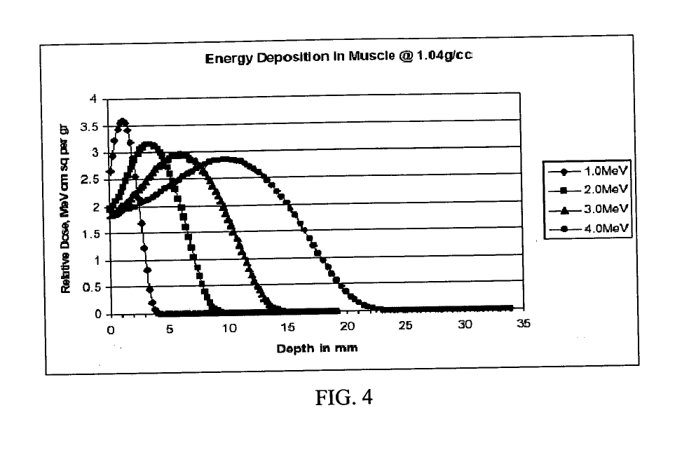

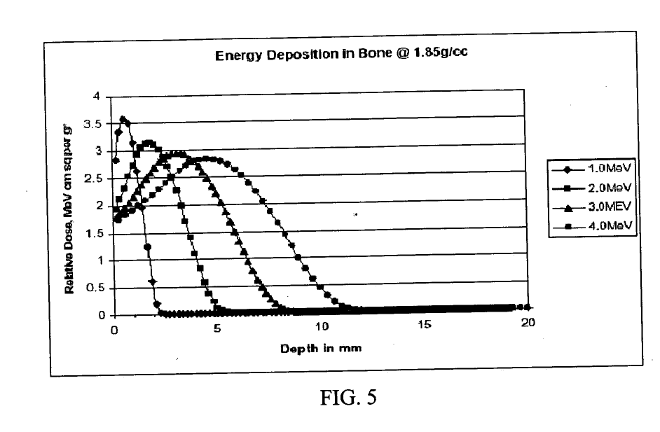

FIGS. 3, 4, and 5 chart delivered dose versus depth in fat, meat and bone tissue for beam energies of 1.0, 2.0, 3.0 and 4.0 MeV. This information shows that the dose delivered in all of these tissues can be limited to a specific depth by adjusting the energy of the electron beam utilized. It should be noted that the density of muscle and bone tissue is about 1.04 g/cc and 1.85 g/cc, respectively, which is denser than fat tissue.

Accordingly, an electron beam of equal energy does not penetrate muscle and bone tissue as deeply as it does fat tissue.

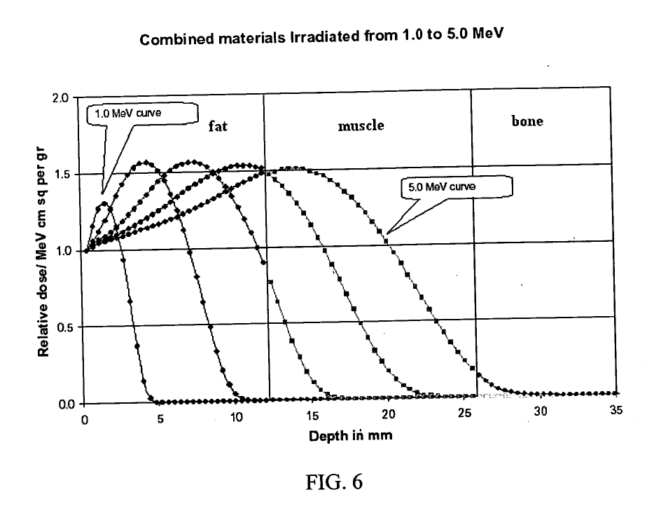

FIG. 6 graphs the dose distribution curves for beam energies of 1.0, 2.0, 3.0 and 4.0 MeV in a combination of overlying materials, namely, approximately 12.5 mm of fat tissue, about 12.5 mm of muscle tissue and about 10 mm of bone tissue, for a total of about 35 mm of combined tissue. This figure mimics the tissue and bone conditions that can be expected in a typical carcass. Electron beam energies of 1.0 and 2.0 MeV only deliver dose to the outer lying fat tissue. Electron beam energies of 3 and 4 MeV deliver dose to the outer lying fat tissue and a minority of the under lying muscle tissue. Electron beam energies of 5 MeV deliver dose to all of the fat tissue, all of the muscle tissue and some of the bone tissue.

Based on the data set forth in FIGS. 2-6, an electron beam energy of less than 4 MeV must generally be employed to insure that a majority of muscle tissue is not irradiated. An electron beam energy of less than 4 MeV penetrates up to about 20 mm of tissue. Conversely, beam energies of at least 500 keV are generally necessary to insure sufficient penetration to kill pathogens within the surface layers of the carcass.

Preferably, electron beam energies of 1 to 3 MeV, and more preferably 1 to 2 MeV, are employed. These beam energies penetrate less than about 15 and less than about 10 mm of tissue, respectively.

5.4 Accelerator/Scanner/Power Source Arrangements

The scanners used in the invention can be positioned above, below or at one or both sides of the passing carcasses. Preferably, the scanners are positioned at one or both sides of the passing carcasses. Each scanner is preferably sufficiently large to deliver dose across the entire length or width of one side of the passing carcasses.

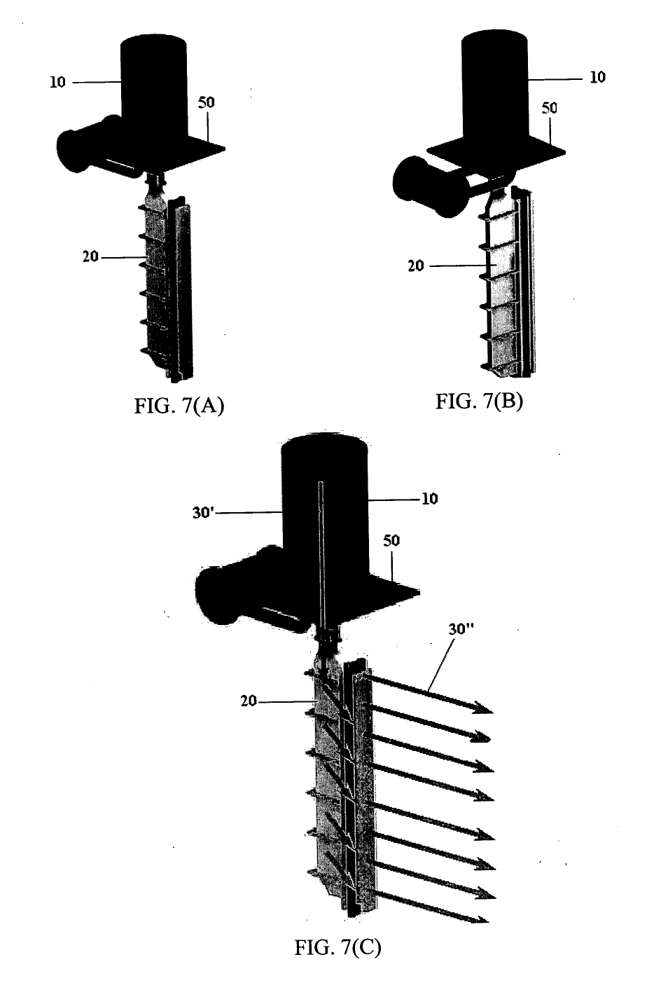

FIG. 7 illustrates an accelerator 10 oriented vertically to a support frame 50. A power source may be integral to or separate from the accelerator. For the purposes of clarity, the shielding over the system and accelerator 10 has been removed. An electron beam 30 is generated inside accelerator 10 and directed down to a beam scanning device 20. The beam scanner uses magnets (not shown) to bend the electrons from a vertical path 30′ to a horizontal path 30′ and distribute them onto the surface of a passing carcass (not shown). In one configuration the length of the scanner 20 is at least ten feet in order to treat the entire height of a passing cattle carcasses. Smaller scanners can be used in other configurations to treat only a portion of a carcass or to treat smaller carcasses, such as pig and poultry.

Such accelerator/scanner arrangements can be deployed in a number of ways. For example, one accelerator and scanner can be employed. Alternatively, multiple scanners can be employed to deliver multiple electron beams emanating from a single accelerator or a plurality of accelerators. Regardless of the configuration, the scanning units are strategically located within the vault to ensure delivery of a relatively uniform dose over the entire carcass in one or more passes.

Illustrative accelerator/scanner/power source arrangements are detailed below:

5.4.1 Plant Concept #1: Multiple Scan Horns

In one embodiment, carcasses are carried by a continuous conveyor system into a vault that contains multiple opposing scan horns. Preferably, each scanner is mounted to a different accelerator and directs an electron beam horizontally toward the surface of the carcass. The dose delivered by each scanner is sufficient to kill pathogens on and in the carcass. This system allows treatment of both sides of the carcass to be completed with one pass through the system.

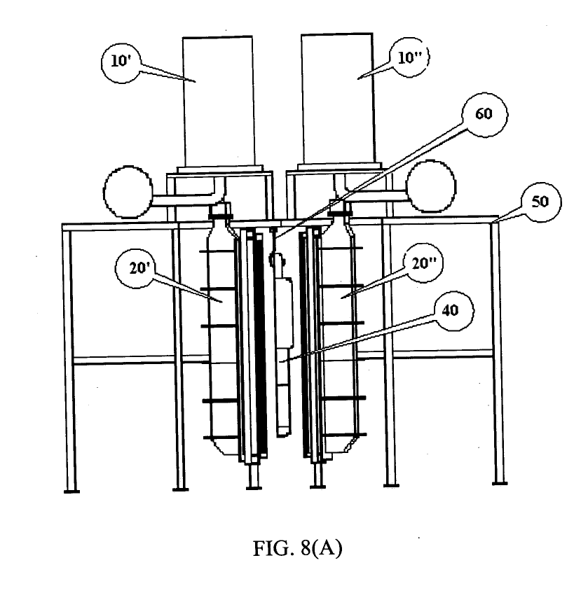

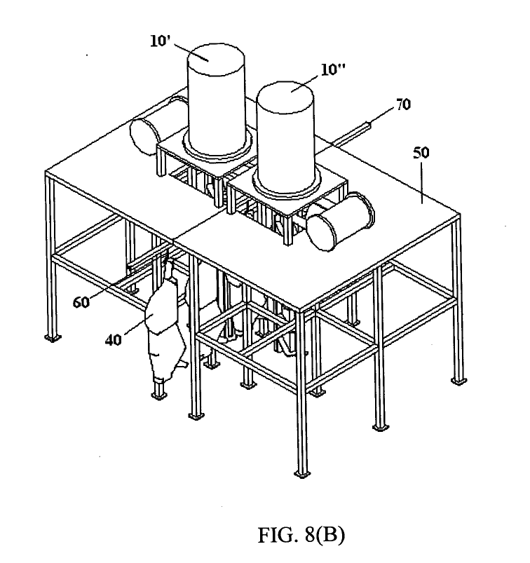

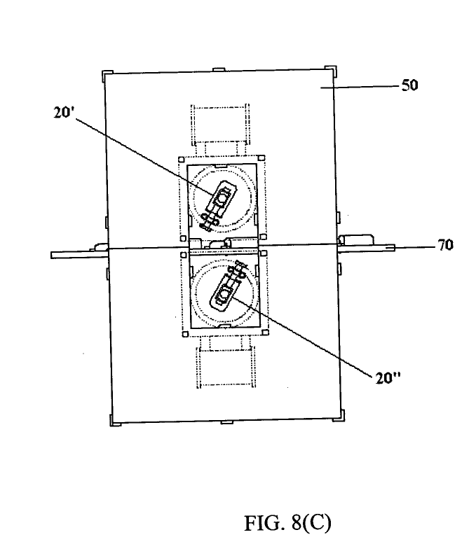

FIGS. 8(A), 8(B) and 8(C) provide front, angled and elevated views, respectively, of such a multiple accelerator arrangement. Once again, for the purposes of clarity, most of the shielding has been removed. Approximate dimensions, including entry and exit shielding, are 25′×50′ with an overhead clearance of 25′.

In FIGS. 8(A), 8(B) and 8(C), two 1.0 or 1.5 MeV accelerators 10′ and 10″ are positioned above a frame 50 that outlines an irradiation vault (not numbered). In this embodiment, individual power sources are relatively small and integral to each accelerator 10′ and 10″. An electron beam (not shown) is generated inside each of accelerators 10′ and 10″ and directed down to opposing beam scanning devices 20′ and 20″ located within the vault. A carcass 40 is conveyed on a continuous conveyor system into the vault on a hook 60 along a conveyor track 70. The carcass 40 is conveyed between scanners 20′ and 20″. The scanners 20′ and 20″ use magnets (not shown) to bend the electron beam (not shown) from a vertical path to a horizontal path and to distribute the electrons onto the entire length of the passing carcass 60. Where, as in this figure, cattle carcasses are irradiated, the length of scanners 20′ and 20″ is preferably at least ten feet to treat the entire height of the carcass 40.

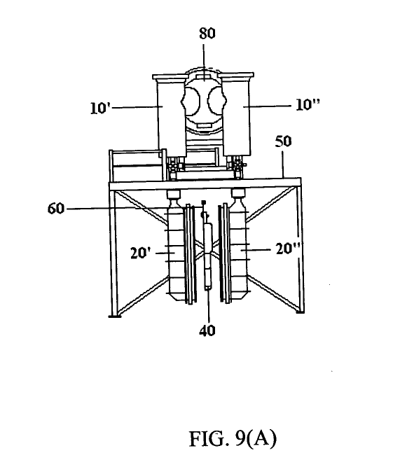

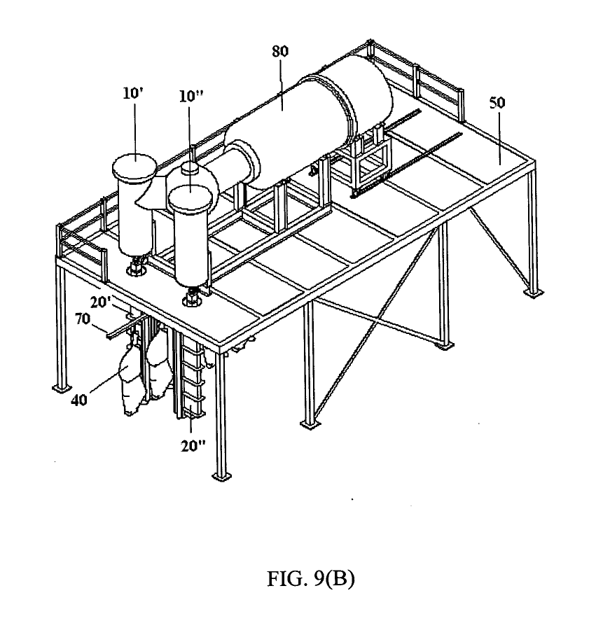

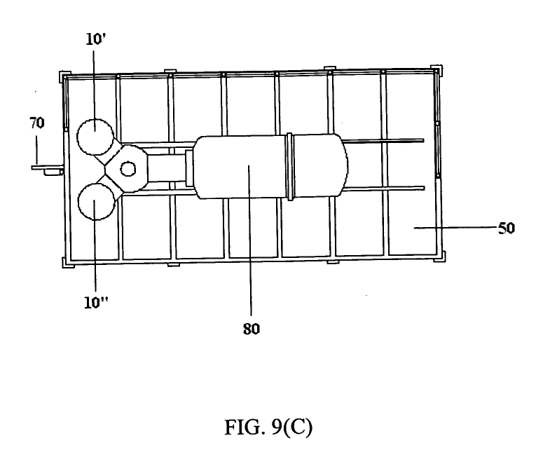

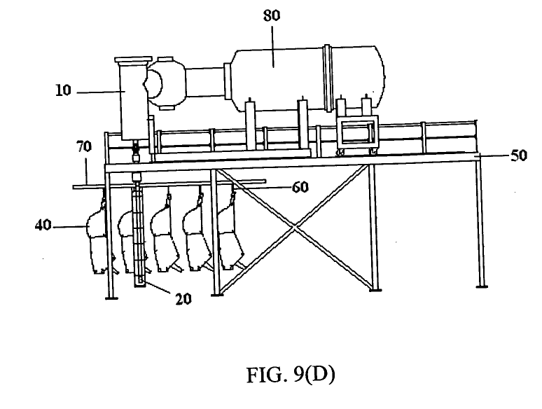

FIGS. 9(A), 9(B), 9(C) and 9(D) provide front, angled, overhead and side views, respectively, of a another accelerator configuration. A single separate and larger power supply 80 powers two higher energy accelerators 10′ and 10″. In this figure, each accelerator is capable of generating up to a 2.0 MeV beam. However, the schematic would be substantially the same using 3.0 or 4.0 MeV accelerators.

Illustrative processing parameters are as follows:

SYSTEM

| | | |
|---|---|---|
| dose | 2.96 | K Gray |
| energy | 1.0 | MeV |
| current | 12 | mA |
| power | 12 | K Watt |
| D(e) | 2.61 | MeV cm²/gr |

UNDER BEAM

| | |
|---|---|
| scan width | 3.36 |
| no. passes | 1 |

THROUGHPUT

| | | |
|---|---|---|
| speed | 18.91 | m/min. |

5.4.2 Plant Concept #2: Single Scan Horn

In another embodiment, carcasses are carried by a continuous conveyor system into a vault where a single scanning unit is used. Preferably, the scanner directs an electron beam horizontally onto and into the carcass. In order to achieve a uniform surface dose distribution, the conveyor may be programmed to tilt the body to face the beam as it moves through the vault. In other words, the body does a dance within the beam to decrease the total surface area hidden from the beam's direct line of sight.

Alternatively or additionally, the conveyor can rotate the carcass 180° outside the vault and re-convey the carcass into the vault for a second pass, thereby, irradiating the opposite side of the carcass with the same scanner. All other factors being equal, the dose delivered should be comparable to that obtained using multiple opposing scan horns.

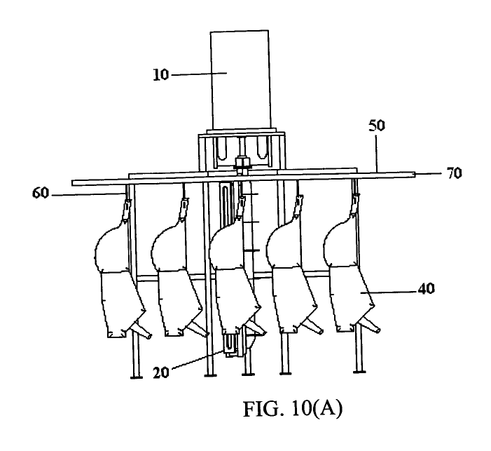

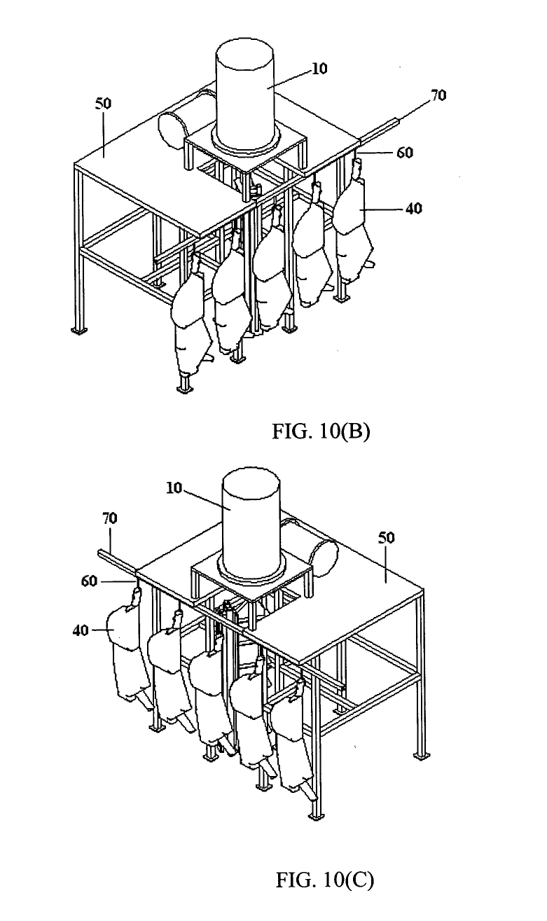

FIGS. 10(A), 10(B), and 10(C) provide side, angled and opposing angle views, respectively, of a single electron accelerator configuration. Once again, for the purposes of clarity, most of the shielding has been removed. Approximate dimensions including entry and exit shielding is 25′×25′×25′.

In FIGS. 10(A), 10(B) and 10(C), one 1.0 or 1.5 MeV accelerator 10 is positioned above a frame 50 that outlines an irradiation vault (not numbered). In this embodiment, the power source is integral to the accelerator 10. Basically, this configuration splits the previous two scanner configuration in half. An electron beam (not shown) is generated inside accelerator 10 and directed down to beam scanning device 20 located within the vault. A carcass 40 is conveyed on a continuous conveyor system into the vault on a hook 60 driven along a conveyor track 70. The carcass 40 is conveyed past scanner 20. Scanner 20 use magnets (not shown) to bend the electron beam (not shown) from a vertical path to a horizontal path to distribute the electrons onto the entire length of the passing carcass 60. Where, as in this figure, cattle carcasses are irradiated, the length of scanner 20 is preferably at least ten feet to treat the entire height of the carcass 40.

5.5 Conveyor System

Any known conveyor system or mixture of conveyor systems can be employed to move carcasses through the maze. A mix of overhead and inverted power and free conveyors and chain conveyors is typical. Suitable conveyor systems are commercially available from companies such as Jervis Webb.

The principle requirement of the conveyor system is that it is sufficient to move and support the body throughout the system and is able to control the speed and angle of a carcass through the electron beam to insure uniform dosing. The applied dose is inversely proportional to the speed of the conveyor through the beam.

Preferably, however, the conveyor system includes one or more overhead hook conveyors such as that illustrated in FIGS. 8(A) through 10(C). In this arrangement, a whole or partial carcass 40 is placed on a overhead hook 60 that is attached to, or propelled by, a powered overhead chain (not shown) along a track 70.

5.6 Maze

A conventional method to assure that all radiation is contained within the vault involves conveying the carcasses through a “maze” of shielding prior to entering the vault. The radiation shielding must be sufficient to allow the transportation of the carcass through the irradiation chamber while protecting personnel working around the system Accordingly, a maze of shielding is designed to create as many as four or five scatterings from interior surfaces to reduce the level of radiation at the entrance and exit of the maze to background levels. Computer codes are commercially available that accurately model radiation levels outside a vault using a given maze design. The maze can be horizontal, vertical, or a combination of both. The walls can be concrete or made of a denser material. Using a denser shielding material, such as steel or lead, instead of concrete, reduces the necessary wall thickness and thus the size of the facility.

5.7 The Method

Accordingly, in one embodiment, the invention comprises a method for reducing the level of pathogens on carcasses. The first step in the method is the generation and acceleration of electrons to an energy between 500 keV and 4.0 MeV. Preferably, the electron beam energy is 1 to 3 MeV and, ideally, 1 to 2 MeV. This amount of electron beam energy is sufficient to kill pathogens but insufficient to penetrate a majority of muscle tissue on the carcass. Primarily outer lying skin and/or fat tissue is irradiated which generally represents no more than about 20 mm of outer lying tissue.

Next, carcasses are moved past one or more scanners using one or more conveyors. The scanners direct the accelerated electrons onto and into each carcass.

The electrons penetrate each carcass to a substantially uniform depth that is less than the total depth of tissue on the carcass. Preferably, the irradiated depth of tissue is about 20 mm or less, more preferably about 15 mm or less, and ideally about 10 mm or less.

The method can employ multiple scanners, e.g., two scanners that irradiate opposite sides of each carcass in a single pass. Alternatively, the method can employ a single scanner that irradiates one side of each carcass on a first pass and the opposite side of each carcass on a second pass. The dose delivered to the surface of the carcass can be uniform. Alternatively, bending magnets can be used to direct a higher concentration of electrons to areas of each carcass that require a higher dose.

Finally, irradiated tissue can be removed from each carcass. In most instances, the irradiated tissue is primarily skin and/or fat tissue. The majority of muscle and bone tissue is not irradiated. A majority, and preferably substantially and more preferably all, of the irradiated tissue is removed. The irradiated tissue can be discarded. Alternatively, the irradiated tissue can be appropriately labeled and sold separately. Still again, the irradiated tissue can be mixed with a higher proportion of non-irradiated meat and sold with or without labels depending on pending FDA and FSIS rulings on the amount of percentage of irradiated product that invokes the labeling requirement. In the latter instance, the amount of irradiated meat in the product would be less than 50% by weight, preferably no more than 25% by weight, more preferably no more than 10% by weight and ideally no more than 5% by weight.

Alternatively, the irradiated tissue can be left on the carcass and the carcass can be divided into parcels of meat that contain a minority of irradiated tissue. The percentage of irradiated tissue in these parcels should be less than 50%, preferably no more than 25%, more preferably no more than 10% and ideally no more than 5% of the total weight. The invention enables meat to be cut from the carcass that contains very little irradiated tissue because only a narrow depth of surface tissue is irradiated. As stated, depending on pending FDA rulings, meat cuts that contain low (e.g., less than 50%) irradiated tissue might be exempt from “irradiation” labeling requirements.

The method eliminates (i.e., kills) 99% or more of the pathogens originally on the carcass. In most cases, the method eliminates 99.9% or more of the pathogens originally on the carcass.

5.8 The System

In another embodiment, the invention comprises a system for reducing the level of pathogens on carcasses. The system comprises one or more carcass conveyors, one or more accelerators that accelerate electrons to an energy between 500 keV and 4.0 MeV and one or more scanners that direct accelerated electrons onto and into carcasses conveyed past the scanners by the conveyors. Each scanner is sufficiently large to irradiate the entire side of a carcass.

In addition, the system comprises a first computer that controls surface dose by controlling electron current, conveyor speed and the number of passes a carcass makes through the system. The system also includes a second computer, that can be the first computer, that controls the energy of the electrons to insure tissue on each carcass is irradiated to a depth less than the total depth of tissue on the carcass.

Adjustment of the electron beam energy effectively controls the depth of treatment. Regulation of the electron beam current, product treatment time, beam scanning and other parameters allow for a controlled dose delivered to the carcass. This dose is adjustable through these parameters and may be set according to the level desired to kill pathogens. The dose delivered is intended to be within the limits of the mandated guidelines for the processing various meats.

The energy of the electron beam is controlled to irradiate outer lying tissue. In other words, up to about 20 mm of tissue, preferably up to about 15 mm of tissue, and more preferably up to about 10 mm of tissue are irradiated. Typically, the irradiated tissue is mostly skin and fat. A majority of the muscle and bone tissue is not irradiated.

The system can employ multiple scanners, e.g., two scanners that irradiate opposite sides of each carcass in a single pass. Alternatively, the system can employ a single scanner that irradiates one side of each carcass on a first pass and the opposite side of each carcass on a second pass. The dose delivered to the surface of the carcass can be uniform. Alternatively, bending magnets can be used to direct a higher concentration of electrons to areas of each carcass that require a higher dose.

5.9 The Carcasses

Finally, in yet another embodiment, the invention includes an irradiated carcass generated by the process or system described above. The irradiated carcass comprises skin and/or fat tissue, muscle tissue and bone tissue. The outer layers of the irradiated carcass, primarily skin and/or fat tissue, have been irradiated with ionizing electrons to a substantially uniform depth, e.g., about 20 mm or less. The deeper tissue in the carcass, primarily muscle and bone tissue, has not been irradiated. The irradiated carcass is substantially free of live pathogens. Preferably, at least 99% of the pathogens have been killed compared to the carcass prior to irradiation. More preferably, at least 99.9% of the pathogens have been killed compared to the carcass prior to irradiation.

5.10 Benefits of the Invention

The invention maximizes the amount of pathogen reduction per unit irradiation energy. Since pathogens live primarily on and in the outer tissue of the carcass, and this tissue is irradiated, the carcasses are made substantially pathogen free without exposing the entire depth of the carcass to ionizing energy. Previously, carcasses were first cut and/or ground into smaller meat products, which spread the pathogens from the carcass throughout the meat. If irradiation was conducted, the smaller meat products had to be fully penetrated with ionizing energy to kill the pathogens admixed therein. The inventive process is more efficient because less product needs to be irradiated to achieve the same effect.

Because a majority of the muscle tissue on the carcass is not subjected to ionizing energy due to the low electron beam energies utilized, meat derived solely therefrom is not “irradiated.” Furthermore, even when irradiated tissue is not removed from the carcass, the invention enables meat to be cut from the carcass that contains very little irradiated tissue because only a narrow depth of surface tissue is irradiated. Depending on pending FDA rulings, meat cuts that contain low (e.g., less than 50%) irradiated tissue may be exempt from labeling requirements. This increases the marketability of the meat.

The invention can be used alone or in conjunction with any other meat sterilization process.

6.0 Incorporation by Reference

All publications, patents and patent applications mentioned in this specification are herein incorporated by reference to the same extent as if each individual publication, patent or patent application was specifically and individually indicated to be incorporated by reference. No admission is made that any reference cited herein is prior art.

1. A method for reducing pathogens from carcasses comprising:
(i) generating and accelerating electrons to an energy between 500 keV and 4.0 MeV;
(ii) moving carcasses using one or more conveyors past one or more scanners;
(iii) directing the accelerated electrons, using the one or more scanners, onto and into each carcass so that each carcass contains a substantially uniform depth of irradiated tissue that is less than the total depth of tissue on the carcass; and
(iv) removing irradiated tissue from each carcass.

2. The method of claim 1 where a majority of the muscle and bone tissue on the carcass is not irradiated.

3. The method of claim 1 where the depth of irradiated tissue on each carcass is up to about 20 mm.

4. The method of claim 1 where 99% or more of the pathogens originally on the carcass are killed by the irradiation treatment.

5. The method of claim 1 where 99.9% or more of the pathogens originally on the carcass are killed by the irradiation treatment.

6. The method of claim 1 where a majority of the irradiated tissue is removed.

7. The method of claim 1 where substantially all of the irradiated tissue is removed.

8. The method of claim 1 where a substantially uniform dose is delivered across the entire surface of each carcass.

9. The method of claim 1 where bending magnets direct a higher concentration of electrons to areas of each carcass that require a higher dose.

10. The method of claim 1 where two scanners irradiate opposite sides of each carcass in a single pass.

11. The method of claim 1 where a single scanner irradiates one side of each carcass on a first pass and the opposite side of each carcass on a second pass.

12. A method for reducing pathogens from carcasses comprising:
(i) generating and accelerating electrons to an energy between 500 keV and 4.0 MeV;
(ii) moving carcasses using one or more conveyors past one or more scanners;
(iii) directing the accelerated electrons, using the one or more scanners, onto and into each carcass so that each carcass contains a substantially uniform depth of irradiated tissue that is less than the total depth of tissue on the carcass; and
(iv) cutting the carcass into portions of meat that contain less than 50% irradiated tissue.

13. The method of claim 12 where 99% or more of the pathogens originally on the carcass are killed by the irradiation treatment.

14. The method of claim 12 where the carcass is cut into portions that contain no more than 25% irradiated tissue by weight.

15. The method of claim 12 where the carcass is cut into portions that contain no more than 10% irradiated tissue by weight.

16. The method of claim12 where the carcass is cut into portions that contain no more than 5% irradiated tissue by weight.

17. The method of claim 12 where a substantially uniform dose is delivered across the entire surface of each carcass.

18. The method of claim 12 where bending magnets direct a higher concentration of electrons to areas of each carcass that require a higher dose.

19. The method of claim 12 where two scanners irradiate opposite sides of each carcass in a single pass.

20. The method of claim 12 where a single scanner irradiates one side of each carcass on a first pass and the opposite side of each carcass on a second pass.

21. A system for reducing pathogens from carcasses comprising:
(i) one or more carcass conveyors;
(ii) one or more accelerators that accelerate electrons to an energy between 500 keV and 4.0 MeV;.
(iii) one or more scanners that direct accelerated electrons onto and into carcasses conveyed past the scanner, where each scanner is sufficiently large to irradiate an entire side of a carcass;
(iv) a first computer that controls surface dose by controlling electron current, conveyor speed and the number of passes a carcass makes through the system; and
(v) a second computer, that can be the first computer, that controls the energy of the electrons to insure that a depth of tissue is irradiated on each carcass that is less than the total depth of tissue on the carcass.

22. The system of claim 21 where the energy of the electrons is controlled to irradiate the outer lying tissue while a majority of the under lying muscle and bone tissue is not irradiated.

23. The system of claim 21 where the energy of the electrons is controlled to penetrate up to about 20 mm of the outer lying tissue of the carcass.

24. The system of claim 21 where a substantially uniform dose is delivered across the entire surface of each carcass.

25. The system of claim 21 where bending magnets direct a higher concentration of electrons to areas of each carcass that require a higher dose.

26. The system of claim 21 where two scanners irradiate opposite sides of each carcass in a single pass.

27. The system of claim 21 where a single scanner irradiates one side of each carcass on a first pass and the opposite side of each carcass on a second pass.

28. An irradiated carcass comprising skin and/or fat tissue, muscle tissue and bone tissue, where outer layers of the irradiated carcass have been treated with ionizing electron energy to a substantially uniform depth and the remainder of the carcass has not been irradiated.

29. The carcass of claim 28 where the carcass has been treated with ionizing electron energy to a depth of up to about 20 mm and the carcass is substantially free of live pathogens.
